(19) United States
(12) Patent Application Publication
(10) Pub. No.: US 2024/0239708 A9
(43) Pub. Date: Jul. 18, 2024

(54) PROCESS FOR CO2 MINERALIZATION WITH NATURAL MINERAL PHASES AND USE OF THE PRODUCTS OBTAINED

(71) Applicant: ENI S.P.A., Roma (IT)

(72) Inventors: Roberto Millini, San Donato Milanese (IT); Michela Bellettato, San Donato Milanese (IT); Giuseppe Bellussi, San Donato Milanese (IT)

(73) Assignee: ENI S.P.A., Roma (IT)

(21) Appl. No.: 17/769,593

(22) PCT Filed: Oct. 16, 2020
(86) PCT No.: PCT/IB2020/059773

§ 371 Date: Apr. 15, 2022

(30) Foreign Application Priority Data
Oct. 18, 2019 (IT) 102019000019256

(51) Int. Cl. C04B 7/13; C04B 28/04; C04B 40/00; C04B 103/00

(52) U.S. Cl. CPC C04B 7/13; C04B 28/04; C04B 40/0042; C04B 2103/0088

(57) ABSTRACT

There is a process of CO₂ mineralization with natural mineral phases with prevalent alkaline-earth metals silicate content producing a mixture of magnesium carbonate, amorphous silica and other possibly non-reacted or non-mineralizable phases. The material thus obtained, after being washed with water, develops pozzolanic properties and can be used for formulating cements.

### CROSS-REFERENCE TO RELATED APPLICATIONS

This Patent Application claims priority from PCT Application No. PCT/IB/2020/059773, which claims priority from Italian Patent Application No. 102019000019256 filed on Oct. 18, 2019, the entire disclosures of which are incorporated herein by reference.

### FIELD OF THE DISCLOSURE

The present disclosure relates to a process of CO₂ mineralization with natural mineral phases with prevalent silicate content of at least an alkaline-earth metal.

### DESCRIPTION OF THE RELATED ART

There exist several types of cement, that differ in composition, strength and durability properties and therefore in their final use.

From a chemical perspective it is generally a mixture of calcium silicates and calcium aluminates, obtained by firing at high temperatures limestone and clay or marlstone (in this case we talk about natural cements).

The obtained material called Portland clinker is finely ground and added with 4-6% of gypsum having setting retardant function (primary ettringite).

Such mixture is traded under the name of Portland cement; once mixed with water it hydrates and sets gradually.

Portland cement is the base of almost all types of cements being presently used in the construction sector. All the other types and sub-types of cement are obtained from the Portland cement mixed with the various supplements available on the market in variable ratios established in any case by the UNI EN 197-1 standard. The different cements are allowed a content of secondary components (fillers or other material) not higher than 5%.

The production of the Portland cement results in the emission of about 0.8-1.0 t_{CO2}/t_{cement}.

Reducing the carbonic intensity of this process is, in fact, rather difficult given the nature of the initial material (containing calcium carbonate) and high treatment temperatures (clinker producing rotary furnaces operating up to 1450° C.). For this reason, supplementary cement materials are already currently used such as fly ashes (ashes flying from carbon power stations) or processing residues from the iron and steel industry (blast furnace slag) or silicon metallurgy (fumed silica).

The advantages deriving from using these materials substantially lie in that they are waste products that would not find any other application and hence intended to be dumped. In terms of emissions, their use avoids emitting a CO₂ amount equivalent to the missed production of Portland cement that they intend to replace.

The materials object of the present technical solution provide an additional contribution both to the overall de-carbonization at company level and in the cement sector in that the CO₂ amount not emitted due to the missed Portland production adds up to the amount steadily and permanently incorporated into the carbonated solid material obtained with the present process.

The reaction of CO₂ with alkaline-earth metal silicates (Mg, Ca) is a known naturally occurring process (natural weathering), according to the general equation:

(Mg,Ca)ₓSi_{y}O_{x+2y+z}H_{2z}+xCO₂→x(Mg,Ca)CO₃+ySiO₂+zH₂O

and, in the specific case of three naturally widespread minerals:

Forsterite: Mg₂SiO₄+2CO₂→2MgCO₃+SiO₂

(uptake: 63 g_{CO2}/100 g_{substrate})

Serpentine: Mg₃Si₂O₅(OH)₄+3CO₂→3MgCO₃+2SiO₂+2H₂O

(uptake: 48 g_{CO2}/100 g_{substrate})

Wollastonite: CaSiO₃+CO₂→CaCO₃+SiO₂

(uptake: 36 g_{CO2}/100 g_{substrate})

The natural process is very slow, as it occurs in presence of humidity by means of carbonic acid attacking the mineral surface. Considering that these mineral phases are abundant in nature (often concentrated in sites even industrially exploited) and that they have a high CO₂ uptake capacity, the possibility of accelerating the weathering process is widely taken into consideration, by adopting suitable reaction conditions.

The advantage of these processes is the ability to permanently fix high amounts of CO₂ at mineral phases (magnesium and/or calcium carbonates and silica) that are stable, inert and harmless for the environment, and that can be simply disposed of.

The accelerated weathering process, or carbonation, as hereinafter defined, was examined in detail by W. K. O'Connor, D. C. Dahlin, G. E. Rush, S. J. Gerdemann, L. R. Penner, and D. N. Nilsen in Report DOE/ARC-TR-04-002 “Aqueous Mineral Carbonation. Mineral Availability, Pretreatment, Reaction Parametrics, And Process Studies” (15, May 2005) and by Z. Y. Chen, W. K. O'Connor, S. J. Gerdemann in the article “Chemistry of aqueous mineral carbonation for carbon sequestration and explanation of experimental results” Environmental Progress 25(2), 161-166 (2006).

Focusing on magnesium silicates, several patents claim processes for the conversion thereof into mixtures of magnesium carbonate and amorphous silica drawing the attention on Olivine, Serpentine and Talc. The focus is mainly on CO₂ fixation in a permanent sequestration perspective, rather than on producing materials for application purposes. For instance it is hereinafter mentioned:

WO 2002/085788 (Shell) discloses mineralization of alkaline-earth metal silicates (e.g. wollastonite) with CO₂ in a slurry consisting in a solution of an electrolyte (NaCl, NaNO₃). The mixture of carbonate and silica can be used in the formulation of construction materials as an inert, preferably using a hydrocarbon binder (e.g. asphaltene, as in WO 2000/046164).

WO 2004/037391 (Shell) discloses a method for capturing CO₂ from flue gas consisting in letting the gas flow into an amine aqueous solution, regenerating the same producing a CO₂ stream which is then sent to a carbonation reactor wherein it reacts with calcium (or magnesium) silicate powder dispersed in water. No mention is made to the use of the solid phase thus obtained.

US 2005/0180910 (Dinsmore & Shohl) discloses a process wherein a finely dispersed magnesium silicate is first treated with an acid solution to solubilize the alkaline-earth metal; afterwards, a gas containing CO₂ is passed into the solution and the pH is increased to precipitate the magnesium carbonate. It is not reported whether the products can be used as construction materials.

WO 2007/060149 (Shell) wherein metal silicates such as serpentine and talc are firstly activated at high temperatures with hot synthesis gas and later reacted with CO₂ to give metal carbonates and silica. It is not reported whether the products can be used as construction materials.

WO 2008/061305 (Orica Explosives Technology (AUS)) discloses a CO₂ sequestration process by mineral carbonation wherein the silicate is activated using heat produced by a fuel combustion.

The activated mineral is treated with CO₂ at high temperature and pressure. It is not reported whether the products can be used as construction materials.

WO 2008/140821 (Carbon Science Inc.) discloses a process for producing finely ground mineral particles and their use for CO₂ sequestration through their carbonation. The metal-carbonates thus obtained can be used as components for construction industry products.

WO 2012/028418 (Novacem) discloses an integrated process for producing components for magnesium-containing cements. The process consists in:
i. preparing an aqueous slurry of magnesium silicate powder (olivine) with particles<1000 μm;
ii. loading this slurry into a reactor wherein it is continuously reacted with CO₂, a soluble salt of the carbonic acid (e.g. NaHCO₃) and, possibly, a chloride or nitrate (e.g. NaCl, NaNO₃), at a temperature of 25-250° C., and at a pressure of 0.5-25 MPa (4.9-247 atm)
iii. extracting the slurry containing magnesium carbonate and silica from the reactor;
iv. separating the solid from mother liquors which will be recycled;
v. heating the solid in a second reactor for producing a solid containing MgO, silica and CO₂;
vi. recycling CO₂ in the first reactor.

In one embodiment of the process described in WO 2012/028418, especially in case the magnesium carbonate produced in the step “ii.” is magnesite (MgCO₃), at least part of the material produced in step “v.” is mixed with a carbonic acid aqueous solution or with an aqueous solution and treated with CO₂ at a pressure of 0.1-1 MPa (preferably 0.1-0.5 MPa) and at a temperature of 25-65° C. to produce a slurry containing nesquehonite [Mg(CO₃)·3H₂O] or at a temperature of 65-120° C. to produce a slurry containing hydromagnesite [Mg₅(CO₃)₄(OH)₂·4H₂O]. The conversion in said carbonation step is maintained as partial, so that the solid product contains non-reacted MgO or Mg(OH)₂. The solids obtained in the carbonation step can be used, furthermore, for formulating cement binders with a lower “carbon footprint” than the Portland cement.

Preferably, the cement binder comprises:
a. 30-80 wt % of a component containing MgO and at least a magnesium carbonate;
b. 70-20 wt % of a second component comprising silica, alumina or aluminosilicates.

Such binder can be used for formulating cements, mixing it in an amount up to 50 wt %, preferably less than 25 wt % with Portland cement or lime, however, the material thus obtained does not exhibit satisfactory pozzolanic properties.

The use of MgO, possibly in a mixture with magnesium carbonate hydrate/hydroxide hydrate, as a cement binder is described in patents WO 2009/156740 (Novacem) and WO 2012/028419 (Novacem).

An alternative process exploiting the CO₂ mineralization process produced in various ways, which allows to conveniently produce a material suitable as a supplementary cement material for formulating cements, replacing part of the Portland cement, is still an existing issue and represents the object of the present disclosure.

The patents and articles published in the scientific literature report the reaction between olivine and CO₂, without granting products pozzolanic properties such to conceive their use as supplementary cement materials in a mixture with the Portland cement. Complex procedures are required to develop pozzolanic properties, with different thermal treatments as well as the need to manage the CO₂ emissions deriving both from post-treatments of the mineralization products and from generating thermal and electrical power required by the process.

It was here unexpectedly found that, by means of a simple post-treatment of the mineralization product, carried out at room temperature and pressure, it is possible to develop pozzolanic properties that make the treated product suitable to be used as a supplementary cement material in a mixture with the Portland cement.

### SUMMARY OF THE DISCLOSURE

There is provided a process of CO₂ mineralization with natural mineral phases with prevalent silicate content of at least an alkaline-earth metal producing a carbonate material comprising a mixture of at least a carbonate of said alkaline-earth metal, amorphous silica and other possibly non-reacted or non-carbonatable phases. The carbonated material has pozzolanic properties and can be conveniently used as a supplementary cement material in cement formulation, with a smaller environmental impact in terms of CO₂ emissions.

The object of the present disclosure is a process of CO₂ mineralization comprising reacting CO₂ with a natural mineral phase with a prevalent content of alkaline-earth metal silicates, preferably Mg, Ca or mixtures thereof, in form of fine particulate, in an aqueous slurry containing up to 35% by weight of said finely ground mineral phase and an alkaline metal carbonate or bicarbonate, preferably Na, K or a mixture thereof, at a temperature from 50 to 300° C. and at a pressure of CO₂≥1.0 MPa (≥9.9 atm), preferably ≥2.0 MPa (≥19.7 atm), characterized in that the product obtained from said process is washed with water until substantial removal of the said alkaline metal from the solid to obtain a carbonated solid material that can be used as a cement additive.

In particular said process of CO₂ mineralization preferably comprises the following steps:
a) preparing a first slurry of the suitable natural mineral powder phase with a diameter d₉₀≤120 μm, in an aqueous solution in presence of alkaline carbonate or bicarbonate, with an initial concentration of the solid equal to or less than 35% by weight with respect to the weight of said first slurry;
b) reacting said first slurry obtained in step a) in a suitable reactor, with CO₂ maintained at a pressure ≥1,0 Mpa (20 bars), preferably constant, and at a temperature ranging from 50 to 300° C., to obtain a second slurry;
c) discharging the second slurry obtained in step b) and separating the solid phase, possibly recycling the mother liquors in step a) for the preparation of the first slurry;
d) washing the solid phase obtained in step c) with water until substantial removal of the alkali metals residues and separating it in order to obtain said solid carbonated material; and optionally
e) drying the solid material obtained in step d).

### BRIEF DESCRIPTION OF THE DRAWINGS

FIG. 1A is a diagram of an isotherm calorimetric measurement for the first 24 hours for the CEMI 52.5R reference cement in example 2.

FIG. 1B is a diagram of an isotherm calorimetric measurement for the first 24 hours for sample “Ex.2_L3”, in example 2.

In FIG. 2 the cumulative heats developed during the whole 168 hours analysis are reported. The pozzolanicity indexes of the different samples is determined from these data, referred to CEMI 52.5R cement, and are reported in the following Table 2.

### DETAILED DESCRIPTION OF THE DISCLOSURE

For the purposes of the present description and the enclosed claims, the scope of the verb “comprise” and terms deriving therefrom means to include also the verb “consist” and “basically consist of” as well as terms deriving therefrom, and associated thereto.

The carbonated solid material obtained after drying in step e) can be conveniently and directly added to the Portland clinker, with no further treatment, except for a possible grinding to make it homogeneous with the Portland granulometry, in order to provide a cement according to the UNI EN 197-1 standard. Alternatively, even the humid solid material obtained at the end of step d) can be added to Portland cement (or another cement fit for the purpose) to obtain a cement material with high pozzolanicity that can be directly used in construction projects.

The terms “carbonated”, “carbonation” and the terms resulting therefrom, as used in the present description and in the claims, refer to materials and reactions wherein, in a solid containing silicate ions, at least a part of the silicate is replaced by carbonate ion by reaction with carbon dioxide (CO₂).

The natural mineral phase that can be used in the process of the present disclosure is with a prevalent use of alkaline-earth metal silicates (preferably at least 60% by weight, more preferably at least 80% by weight, relative to the overall weight of the mineral), in particular Mg or Ca, preferably Mg, possibly in a mixed phase with other metals, including transition metals such as Fe, Mn, Ni, as, for example, olivine (whose general formula can be expressed as (Mg,Fe)₂SiO₄), serpentine (Mg₃Si₂O₅ (OH)₄), wollastonite (CaSiO₃). Preferably, the natural phase used in the present process is a mineral with a prevalent content of magnesium silicate (Mg₂SiO₄), more preferably consisting of olivine, which has a high content of forsterite and it is extremely abundant and concentrated in nature.

Serpentine, though widely studied, is shown to react with CO₂ after being duly heat-treated at 600-650° C.

Finally, wollastonite, though more reactive, is naturally present but not in the amounts and concentrations as olivine.

In step a), a first slurry containing the natural mineral powder phase is prepared in an aqueous solution of an alkaline carbonate or bicarbonate, preferably at a concentration of 0.1-2.0 M, preferably 0.3-1.1 M, more preferably 0.5-1.0 M. Na and K carbonates or bicarbonates are the preferred ones, more preferably Na.

Powder granulometry is an important parameter in that, being the mineralization reaction a solid-liquid process, its rate increases as the particles average size diminishes. d₉₀ defines the size of the sieve through whose meshes at least 90% by weight of the sample passes, its value must be ≤300 μm, preferably ≤100 μm and still more preferably ≤30 μm.

The initial concentration of the slurry must take into consideration that the mineralization phase leads to the weight increase and volume expansion of the solid and, consequently, to a slurry densification.

The maximum initial concentration of the natural mineral phase dispersed in the aqueous solution is thus conveniently limited to values which do not compromise the rheologic characteristics of the slurry during the process, preventing the efficient mechanical stirring.

Meanwhile, the concentration must be kept sufficiently high so as to guarantee a good process yield. These conditions are reached with an initial maximum concentration of 35% by weight, preferably 25% by weight, to ease separating the solid from mother liquors by decantation.

In step b), the first slurry prepared in step a) is loaded in a reactor with proper mechanical stirring wherein it is reacted with CO₂ being maintained at a pressure≥1.0 MPa, preferably ≥2.0 MPa, at a temperature between 50 and 300° C., preferably between 100 and 200° C., more preferably between 120 and 170° C., preferably for a time lapse between 0.5 and 200 hours, preferably between 1 and 50 hours, more preferably between 1 and 20 hours, to obtain a second slurry which comprises the, still impure, desired cement product.

The mineralization reaction is conveniently carried out in a suitable reactor capable to operate at desired pressures and temperatures, for example in an autoclave. Preferably the operation is carried out at a CO₂ pressure in the range 3-25 MPa (29.6-247 atm), more preferably 5-15 MPa (49.3-148 atm), at the temperature in the range 100-200° C. In full capacity conditions, pressure is preferably maintained almost constant at the desired value.

For the purposes of the present process, it is preferred to supply CO₂ having the utmost purity, to maximise the reaction and conversion rate. CO₂ with a purity >80% is preferred, more preferably >95%. CO₂ suitable for the process of the present disclosure can be for instance obtained from capture processes from coal, natural gas and other fuel combustion fumes; it can also derive from capture processes from fumes of industrial processes of cement, refinery, petrochemical plants, etcetera; it can result from natural gas separation and purification processes; it can result from air separation processes (Direct Air Capture). Other gases that can be contained in CO₂ supplied in step b) of the present process are nitrogen, oxygen, methane, carbon monoxide and hydrogen. Furthermore, sulphur oxides SOx can be contained, which presumably stay in a solution as sulphates and sulphites, and H₂S, which can presumably react with Fe possibly contained in the mineral, forming substantially inert insoluble sulphides, which do not jeopardise the quality of the end-product.

In step c) said solid phase is separated from the reaction liquid contained in the second slurry produced in step b), preferably after de-compression at room pressure, by any one of the methods fit for the purpose, many of which are also used on an industrial scale, in particular, filtration, decantation or centrifugation, more preferably filtration or decantation. Separation is normally carried out at room temperature or higher, up to the boiling temperature of the aqueous phase.

The mother liquors thus separated contain the greatest part of the alkaline carbonate or bicarbonate used in step a) and may be conveniently recycled at said step for preparing a new slurry to add a mineral phase.

At the washing step d) alkaline metals, particularly Na and K are considered as substantially removed from the solid when the following test is passed:

100 mg of dried solid is suspended in 1 litre of distilled water and kept under stirring for at least 24 hours; the alkaline metal or metals content in the aqueous liquid of the suspension must be lower than or equal to 1.0 mg/L, preferably 0.5 mg/L, more preferably 0.2 mg/L. Determining the concentration of alkali metal in the liquid may be carried out with any one of the known methods fit for the purpose, for example, by atomic absorption spectroscopy.

The solid washing is carried out with water, that can be natural water or water for industrial use. In general water with an alkali metal content lower than 100 mg/L, more preferably lower than 50 mg/L is preferred. The washing may be carried out at subsequent steps, interposed by separating the solid from washing waters by the above mentioned known techniques, or may be continuously carried out, for instance countercurrent. The washing is normally carried out at room temperature or slightly higher.

The optional drying step e) can be carried out with any one of the known techniques for drying mineral solid materials. Drying is conveniently carried out in air, or even under reduced pressure in suitable static or rotating driers: it can occur at room temperature, or preferably, at a temperature of 80-200° C., preferably of 100-150° C., more preferably of 120-130° C., possibly under air streams, in suitable apparatuses such as ovens, furnaces or other heating systems.

The CO₂ amount fixed in the final product (Uptake_{CO2}) is determined by thermogravimetric analysis (TGA), measuring the loss associated to the magnesium carbonate decomposition in the range 450-650° C., according to the reaction:

MgCO₃→MgO+CO₂

The X-ray powder diffraction (XRD) is used to determine the qualitative phasic composition of the materials.

The characterizing aspect of the present disclosure is represented by the pozzolanic properties of the carbonated solid product obtained from the CO₂ mineralization, which enables to directly use it as a supplementary cement material in a mixture with the Portland cement. The pozzolanic properties are related to the presence of amorphous silica and the features thereof. The amorphous silica is in fact able to react with the slaked lime (Ca(OH)₂), formed by hydrating the Portland cement in cement conglomerates, resulting in hydrated calcium silicates characterized by binding properties.

Another object of the present disclosure consists in the carbonated solid material comprising amorphous silica and at least an alkaline-earth metal carbonate, preferably Mg or Ca, which can be obtained, in the humid or dried form, by the herein described and claimed process, said material being usable as an additive for cements, particularly for Portland cement. In particular, said carbonated solid material is preferably characterised by an overall concentration of Na and/or K lower than 2% by weight, more preferably lower than 1% by weight, still more preferably lower than 0,5% by weight, referring to the total weight of the solid material air-dried at 120° C. for 2 hours. A further aspect of the present disclosure is therefore a construction material comprising 35 to 99%, 60 to 95% by weight of Portland cement and 1 to 65%, preferably 5 to 40% by weight of the carbonated solid material obtained according to the process as herein described and claimed.

The pozzolanic properties of a supplementary cement material that can be used as a cement additive, are expressed by the so-called equivalence factor (Keq), expressing the amount of Portland cement that can be replaced by 100 kg of this material to produce a cement conglomerate characterised by the same mechanical properties. The Keq factor is established based on the Abrams' law, as described in the publication to G. Appa Rao in “Cement and concrete research”, vol. 31 (2001), pp. 495-502.

An index related to the aforesaid Keq is represented by the pozzolanic activity index P^{N} which can be measured by determining the pozzolanic reactivity of the supplementary cement material by means of a method based on measuring the hydration heat with a semi-adiabatic/isoperibolic calorimeter. It is a direct method for measuring the pozzolanic reactivity, in that it measures the reaction progression at pre-set times. The semi-adiabatic calorimetry measures the heat developed by a reaction through the temperature increase of the reactant medium contained in an isolated vessel (as described in Brandetetr J., Polcer J., Kritky J., Holesinsky R., Halvlika J., “Possibilities of the use of isoperibolic calorimetry for assessing the hydration behavior of cementitious systems”, Cement and Concrete Research 31 (2001) 941-947) and it represents the base of the European EN 196-9:2010 standard. In this measurement, the heat flow between the reactant medium and the outer environment is kept constant, interposing between the two an insulating vessel that ensures a high exchange strength. The pozzolanic reactivity of a supplementary cement material is measured comparing the cumulative hydration heat developed by a reference cement-based paste and that developed by a paste consisting of a an equal-weighed mixture (1/1 by weight) of reference cement and supplementary cement material. At the pre-set deadline, typically after one week (168 hours), the cumulative heat developed by the mixture is related to the heat developed by the reference cement and the pozzolanic activity index resulting therefrom is the ratio between the two values. The following relation is used:
where:

$${P}_{X}^{N} = ( {Q}_{X}^{N} - 1 / 2 {Q}_{Ref}^{N} ) / 1 / 2 {Q}_{Ref}^{N}$$

P_{X}^{N} is the pozzolanicity index after N days of the sample X;
Q_{X}^{N} is the cumulative hydration heat per mass unit of the equal-weighted mixture containing the sample X, developed after N days;
Q_{Ref}^{N} is the cumulative hydration heat per mass unit of the reference cement, developed after N days.

Thereby, if the added material is inert, the pozzolanicity index is zero, while the reference cement has a pozzolanicity index of 1.

In practice, the use of the carbonated solid material before the washing highlighted a notable reduction in the P^{N} index, substantially behaving as an inert material. This behaviour was ascribed to the presence in the sample of sodium ions which, interacting with the amorphous silica, prevent the reaction with the slaked lime present in the cement.

After removal of sodium by simple washing with water, the carbonated material according to the present disclosure surprisingly developed high pozzolanic properties, reaching a P² index higher than 0.9. This amounts to saying that 100 kg of carbonated material, obtained by the process of the present disclosure, can replace 90 kg of Portland cement, with consequent advantages as regards the reduction of CO₂ emissions resulting from the concurrent smaller production of Portland cement and the use of a material obtained by reaction with a natural silicate of an alkaline-earth metal, wherein CO₂ is steadily and permanently fixed.

### EXAMPLES

Experimental Part

A mineral containing 83% by weight of Olivine is used with a composition Mg_{1.8}Fe_{0.2}SiO₄ (determined with a high resolution field emission scanning electronic microscope (FESEM) JEOL 7600F operated at 15 kV equipped with an energy dispersion spectrometer (EDS)) and as non-reactive minority phases towards CO₂ in the adopted conditions, Enstatite (MgSiO₃), Flogopite (KMg₃(Si₃Al)O₁₀(F,OH)₂, Edenite (NaCa₂Mg₅Si₇O₂₂(OH)₂). This mineral has a maximum Uptake_{CO2} calculated in 50 g_{CO2}/100 g_{substrate}.

An AISI 316 steel 1L Brignole autoclave is used that is electrically heated and equipped with an anchor stirrer with an adjustable speed between 0 and 400 rpm and a thermocouple for measuring the inner temperature.

The CO₂ flow continuously supplied is regulated by a Brooks flowmeter installed on the supply line; the desired pressure is reached thanks to two syringe pumps Teledyne ISCO model 500D, always installed on the supply line.

The autoclave is also equipped with a gas outlet line, whose volume is measured by a Ritter, Drum-type gas meter TG1/1.

The phasic composition of the mineral and of the carbonation products was determined by means of X-ray powder diffraction (XRD), using a Philips X′PERT vertical diffractometer equipped with a pulse proportional counter and secondary curved graphite crystal monochromator. The diffraction patterns were collected in the angular range 3≤2θ≤80°, with step of 0.03° 2θ and accumulation times of 20 s/step; the radiation used is CuKα (λ=1.54178 Å). The crystal phase identification was terminated by the Searchmatch method implemented in the X′Pert HighScore software traded by PANalytical.

The amount of CO₂ contained in the carbonate form in the carbonated product (Uptake_{CO2}) was determined by thermogravimetry analysis (TGA) using a thermo-analyser Seiko model TG/DTA6300, equipped with an alumina furnace operating up to 1300° C. Measurements were carried out using an amount of about 10 mg of sample, housed in an alumina crucible placed in the middle of the furnace. A constant gas flow of 50 cc/min was sent from the bottom of the analyser and the heating ramps were of 10° C./min from room T to 950° C.

Calorimetric measurements for determining the pozzolanic properties were carried out with an OM-CP-OCTTEMP 2000 semi-adiabatic/isoperibolic calorimeter from Omega Engineering capable of measuring simultaneously up to 8 samples. The temperature of each sample and the room temperature are measured with thermocouples type K(Nickel-chromium/nickel alumel). The thermal exchange characteristics inside the instrument are calibrated with a reference fluid (water) and, thanks to knowledge of the specific heat of the reactant system, the hydration heat flow (in Watt per gram of binder, W/g_{binder}) and the hydration cumulative heat (in Joule per gram of binder, J/g_{binder}) are obtained.

### EXAMPLE 1 (COMPARATIVE): MINERALIZATION TEST WITHOUT WASHING STEP

500 mL of a slurry containing 25% of finely ground olivine (Ød₉₀<100 μm) dispersed in a 0.5 M NaHCO₃ aqueous solution is charged in the autoclave. Once the autoclave is closed, it is heated at 135° C. and CO₂ is introduced until it reaches the pressure of 12.2 MPa (about 120 bars), pressure maintained by continuously supplying CO₂. After a 6-hour reaction, the autoclave is returned to room temperature and pressure and the slurry is discharged; the solid is filtered and air-dried at room temperature.

The subsequent analysis by X-ray powder diffractometry (XRD) reveals that the sample is a mixture mainly containing magnesite (magnesium carbonate, MgCO₃) and amorphous silica, together with small amounts of non-reacted forsterite and other non-carbonatable phases contained in the initial mineral (phlogopite, enstatite, edenite).

The sodium content, determined by elemental analysis of the air-dried sample at 120° C., is 3.0% by weight of Na.

### EXAMPLE 2: MINERALIZATION TEST WITH WASHING STEP

The Example 1 is repeated under the same conditions, with the only difference that the solid separated at the end of the reaction is submitted to repeated washes with water to remove the residual NaHCO₃/Na₂CO₃. In particular, the solid is subdivided into four aliquots. One of them is dried with no further treatments (sample Ex.2-NL), the other ones are submitted to 1, 2 and 3 subsequent washes with demineralised water (samples Ex.2-L1, Ex.2-L2, Ex.2-L3). Each wash is carried out using 1 ml of water per gram of solid, under magnetic stirring for 15 minutes. The solid is separated by filtration and possibly re-dispersed in mineralised water for the second and third wash. At the end, solids are air-dried at room temperature.

The sodium content in the four samples is reported in Table 1.

TABLE 1
sodium content in the samples

| Sample | Na (% by weight) |
|---|---|
| Ex. 2_NL | 3.0 |
| Ex. 2_L1 | 1.3 |
| Ex. 2_L2 | 1.0 |
| Ex. 2_L3 | 0.2 |

The thermo-gravimetric analysis (TGA) of the sample washed three times, Ex.2-L3, underlines the presence of a weight loss of 20.5% in the region 400-650° C., related to CO₂ loss deriving from the decomposition of magnesium carbonate. The Uptake_{CO2} is therefore of 25.7 g_{CO2}/100 g_{substrate}, corresponding to a conversion of 53% of the present silicate magnesium.

The XRD analysis of the washed samples does not detect substantial differences if compared to what detected in the sample analysis before washing it (Example 1).

Investigations by means of scanning electron microscopy together with energy dispersed X-ray analysis (SEM-EDS) underlines that the sample Ex.2-L3 mainly consists of a mixture of magnesium carbonate crystallites (having size 1-3 μm) and amorphous silica particles, deriving from the reaction of the magnesium silica with CO₂.

### EXAMPLE 3

The Example 1 is repeated under the same reaction conditions and using the same reactants, however increasing the NaHCO₃ concentration to 1 M and prolonging the reaction with CO₂ for 24 hours rather than 6 hours. The sample thus obtained was washed three times and typified as in the Example 2. The Na content in the sample is <0,15% by weight.

The XRD analysis on the sample thus obtained indicated that the material is mainly composed of magnesite and silica, together with small amounts of secondary non-carbonatable phases contained in the initial mineral (phlogopite, enstatite, edenite).

The thermo-gravimetric analysis (TGA) underlines the presence of a weight loss of 31.2% in the region 400-650° C., related to CO₂ loss deriving from the decomposition of magnesium carbonate. The Uptake_{CO2} is therefore of 45 g_{CO2}/100 g_{substrate}, corresponding to a conversion of 92% of the present magnesium silicate.

### EXAMPLE 4 (COMPARATIVE)

The CO₂ mineralization reaction is carried out using the conditions reported in the patent application WO 2012/028418. After 1 hour reaction, the solid obtained was washed with water and submitted to XRD analysis highlighting the absence of magnesium carbonate, indicating that, under the conditions reported in WO 2012/028418, the substrate does not significantly react with CO₂.

### EXAMPLE 5

The Example 1 is repeated limiting the reaction time to 1 hour. After washing with water (as in Example 2) TGA analysis indicated an Uptake_{CO2} of 12,6 g_{CO2}/100 g_{substrate}.

### EXAMPLE 6: EVALUATION OF THE POZZOLANIC PROPERTIES OF THE CARBONATED SOLID

Calorimetric tests were carried out using the CEMI 52.5R Portland cement as a reference cement and equal-weighted mixtures thereof with the carbonated material in the first place (for comparative purposes) and after repeated washes with water.

For each sample, calorimetric measuring was carried out on a slurry obtained mixing the powdered solid and water with a liquid/solid weight ratio=0.5.

Each slurry was prepared by mixing a predetermined amount of the powdered solid with water using a turbine blade stirrer, at a rate of 400 rpm for three minutes. For each mixture, 60,0±0,1 g of a sample is accurately weighted in the 80 ml volume measuring insulating vessel. A thermometric well is inserted within the slurry where the thermocouple is housed for measuring the sample temperature. The vessel is closed to avoid water evaporation. Vessels are then housed in an insulated chamber where thermocouples are placed for measuring the room temperature, kept constant at 22° C. The sample and room temperatures are acquired every 30 seconds and recorded.

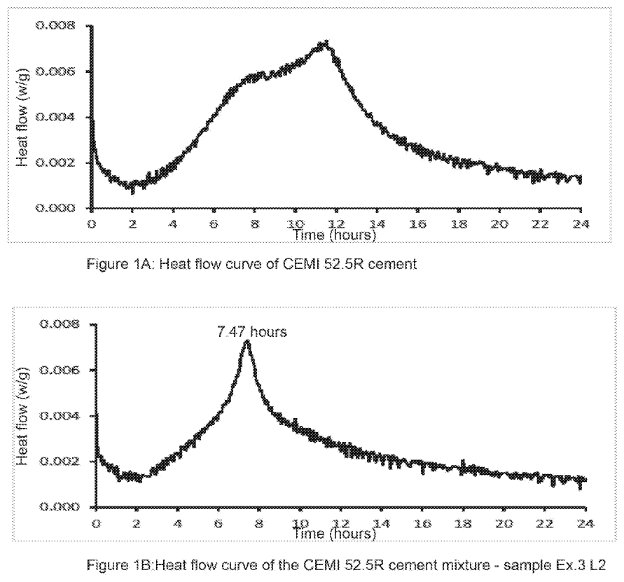

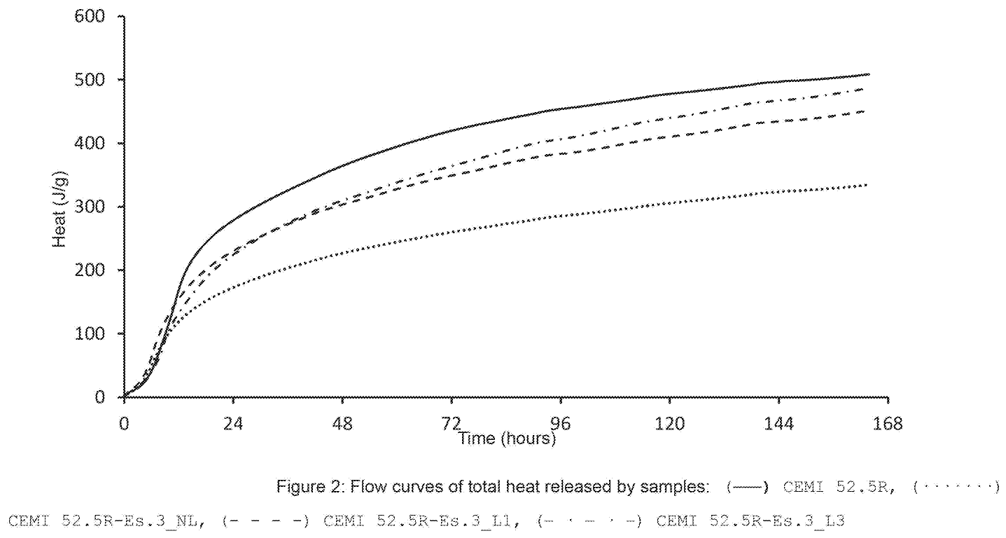

In FIGS. 1A and 1B the diagrams obtained throughout the isotherm calorimetric measuring are respectively reported, only for the first 24 hours analysis, for the CEMI 52.5R reference cement and for the sample “Ex.2_L3”, obtained as described in the example 2.

In FIG. 2 the cumulative heats developed during the whole 168 hours analysis are reported. The pozzolanicity indexes of the different samples is determined from these data, referred to CEMI 52.5R cement, and are reported in the following Table 2.

TABLE 2
Pozzolanicity indexes

| | P⁷ |
|---|---|
| Sample | (Pozzolanicity index after 7 days) |
| 1 - CEMI 52.5R | 1.000 (reference) |
| 2 - Ex. 2_NL | 0.315 |
| 3 - Ex. 2_L1 | 0.771 |
| 4 - Ex. 2_L2 | 0.767 |
| 5 - Ex. 2_L3 | 0.907 |

The sample reactivity, referred to CEMI 52.5R cement, increases from the non-washed sample (Ex.2_NL), which shows a very low reactivity with respect to washed cements, not enough to be used as a Portland cement additive. In particular the sample Ex.2 L3, characterized by a low sodium content, has a very high pozzolanicity index (0.907), very close to that of the reference cement and can be used as a supplementary cement material.

The calorimetric test carried out with the slurry obtained with the carbonated material before the washing underlined very low pozzolanic properties, not enough to justify its use as a supplementary cement material. This behaviour was ascribed to the presence in the sample of sodium ions which, interacting with the amorphous silica, prevent the reaction with the slaked lime present in the cement.

Surprisingly, the pozzolanic properties have notably improved after repeated washes with water, with a pozzolanicity index higher than 0.9 after three consecutive washes, thus very close to the reference cement one. This enables us to state that the carbonated material, after substantial sodium removal can be used as a supplementary cement material replacing part of the Portland cement, resulting in advantages regarding CO₂ emission reduction, deriving from the simultaneous production of Portland cement and from the use of a material produced by reaction with an alkaline-earth metal natural silicate, wherein CO₂ is stably and permanently fixed.

The process and the compositions as herein described and illustrated, may be further modified by the skilled in the art according to variants not specifically herein mentioned, which in any case must be considered comprised as clear embodiments of the present disclosure within the scope of the enclosed claims.

1. Process of CO₂ mineralization, comprising, reacting CO₂ with a natural mineral phase having a prevalent alkaline-earth metals silicate content in the form of fine particulate matter in an aqueous slurry including up to 35% by weight of the finely ground mineral phase and an alkali metal carbonate or bicarbonate at a temperature of 50 to 300° C. and a CO₂ pressure ≥1.0 MPa and washing a solid product obtained from the reaction with water until substantial removal of the alkaline metal to obtain a solid carbonated material.

2. Process according to claim 1, comprising the following stages:
a) preparing a first slurry the natural mineral powder phase having a diameter d₉₀≤300 μm in an aqueous solution in presence of an alkaline carbonate or bicarbonate with an initial concentration of the solid equal to or less than 35% by weight with respect to the weight of the first slurry;
b) reacting the first slurry obtained in stage a) in a suitable reactor with CO₂ maintained at a pressure ≥2 MPa and at a temperature ranging from 50 to 300° C. to obtain a second slurry;
c) discharging the second slurry obtained in step b) and separating the solid phase;
d) washing the solid phase obtained in step c) with water until substantial removal of the alkali metals residues and separating it in order to obtain the solid carbonated material and, optionally,
e) drying the thus obtained solid material.

3. Process according to claim 2, wherein the solid phase in stage c) or the solid phase in step d) is separated by filtration, decantation or centrifugation.

4. Process according to claim 1, in which the natural mineral phase is olivine.

5. Process according to claim 1, wherein the concentration of the alkaline carbonate or bicarbonate in the aqueous slurry or in the first slurry of the stage a) ranges between 0.1 and 2.0 M.

6. Process according to claim 2, wherein the temperature in stage b) varies between 120 and 170° C.

7. Process according to claim 1, wherein the concentration of mineral phase in the slurry is from 25 to 35% by weight.

8. A solid carbonated material useful as an additive for cements, comprising amorphous silica and at least one alkaline-earth metal carbonate obtainable from the process according to claim 1.

9. A solid carbonated material according to claim 8, wherein the total concentration of Na and/or K is lower than 2% by weight with respect to the total weight of the solid material dried in air at 120° C. for 2 hours.

10. Building material, comprising from 35 to 99% by weight of Portland cement and from 1 to 65% by weight of the solid carbonated material according to claim 8.

11. Process according to claim 1, wherein the prevalent alkaline-earth metals silicate content is preferably Mg, Ca, or mixture thereof, and wherein the alkali metal carbonate or bicarbonate is Na, K, or a mixture thereof.

12. Process according to claim 1, wherein the alkaline carbonate or bicarbonate is Na, K carbonate or bicarbonate, or a mixture thereof, wherein the suitable reactor is maintained at constant pressure, wherein mother liquors are recycled into stage a), wherein the alkali metals residues are of Na and/or K, and wherein the solid carbonated material is dried.

13. A solid carbonated material according to claim 8, wherein the cements are Portland cements, and wherein the at least one alkaline-earth metal carbonate is Mg or Ca.

14. A solid carbonated material according to claim 9, wherein the total concentration of Na and/or K is lower than 1% by weight.

15. A solid carbonated material according to claim 14, wherein the total concentration of Na and/or K is lower than 0.5% by weight.

16. Building material according to claim 10, comprising from 60 to 95% by weight of Portland cement and from 5 to 40% by weight of the solid carbonated material according to claim 8.
